(19) United States
(12) Patent Application Publication
(10) Pub. No.: US 2020/0223349 A1
(43) Pub. Date: Jul. 16, 2020

(54) Multi-Purpose Cooler and Tool Housing for Vehicular Integration

(71) Applicant: Christian M. Zanca, Harlingen, TX (US)

(72) Inventor: Christian M. Zanca, Harlingen, TX (US)

(21) Appl. No.: 16/739,425

(22) Filed: Jan. 10, 2020

Related U.S. Application Data
(60) Provisional application No. 62/790,515, filed on Jan. 10, 2019.

(51) Int. Cl. B60P 3/20; F25D 3/06

(52) U.S. Cl. CPC B60P 3/20; F25D 3/06

(57) ABSTRACT

Embodiments of the Multi-Purpose device detailed herein include the combination of a tool box and an ice chest mounted in a vehicle such as a crossover style on the top of the bed rail of open bed pickup trucks. The device may be referred to herein as a “Coolchest”. The outside of the Coolchest may be made of a one piece aluminum tub or other suitable material. Inside of the Journeyman's outer shell of aluminum may be a rotomolded cooler mold filled with polyurethane or other suitable polymer selected for manufacturability and performance purposes. For example, a layer of polyurethane may be in between the aluminum and the rotomold, as well as filling the hollow portion of the rotomold. In one embodiment, the Coolchest's rotomold will have a gently sloping bottom, so that as ice melts the water will slowly drain towards the plug located near the front of the bottom right corner of the ice chest side. The plug can be easily reached from the side of the truck due to its location. The plug will be a simple screw in and screw out design. Options include different proportions for the sections of the Coolchest, such as, but not specific to, ½ ice chest and ⅔ toolbox, or ½ ice chest and ½ toolbox, or ⅓ toolbox and ⅔ ice chest. The toolbox and ice chest sections may be divided by an aluminum wall with specific placement depending upon the proportions of the ice chest section. The tool chest section of the Coolchest may preferably be located on the driver's side of the truck. The lids open to 90 degrees and self closes for easy one hand operation. They may open separately and lock separately by a pair of easy to use twist handles that also offer top of the line security by using a rotary latch on the inside and gas spring support. The handles are set widely apart, making for easy reach from the sides of the truck. Multiple sizes are possible for a custom fit for each truck model, as well as pre-drilled mounting slots and the necessary hardware for installation.

### FIELD

Embodiments of the device detailed herein are in the field of apparatuses used in open-backed vehicles such as pick-up trucks and other vehicles where a tool box and ice chest can be used simultaneously in the vehicle. Any discussion of the prior art throughout the specification should in no way be considered as an admission that such prior art is widely known or forms part of common general knowledge in the field. Tool boxes and ice chests have both been in use throughout millennia in different forms and fashions. Tool boxes, especially mounted tool boxes usually are composed of a box with a lid wherein different chambers lie, that have different compartments and locations for various tools and accessories. Ice chests have a long history, where they all share the same general components: a chest, ice, and various forms of insulation to prolong the usage of ice and keep contents inside cold.

Problems with mounted tool boxes and ice chests are that they require a considerable amount of space to carry if someone uses them on a regular basis which would restrict the amount of use the rest of the vehicle can have. It also requires the purchase of two separate products which (for high end coolers and tool boxes) can be substantially expensive. Each product also has their shortcomings as well, with some providing inadequate insulation to improper drainage engineering. Some mounted tool boxes have an obvious amount of wasted space and do not utilize the full potential of being simultaneously mounted and serving as a tool box to its advantage. In these respects, the Coolchest (or “Journeyman Coolchest”) substantially departs from conventional concepts and designs of current tool boxes and ice chests on the market by combining the two of them in a mounted concept for pick-up trucks and open-backed vehicles where both tool boxes and ice chests are utilized often.

### SUMMARY

This invention relates to rear mounted pick up tool boxes that are stabilized and immobile for pickup trucks, or other open/close ended vehicles that utilize tool boxes. It is an embodiment of a tool box and its components and an ice chest with its components with the functionality of both.

It is an object of the invention that will provide the inclusion of a tool box and ice chest hybrid (and other embodiments) that will function as a multi-purpose storage center where on the original model, one section of the aforementioned product may be utilized as an ice chest with a separate hinged lid while the other section can be used as a tool box, dry storage, or multi-functional box that will keep materials secure and away from the elements which has a separated wall that will insulate either side from each other and from the elements. Other embodiments consist of, but are not limited to, a one-third tool box, two-thirds ice chest; two-thirds tool box, one-thirds ice chest, and a full-ice chest model.

It is another object that combined these unique features together that compromises but is not limited to the following, an external reinforced aluminum plating textured surface and side walls, a self-draining and angled bottom surface that offers convenience of drainage and usage without sacrificing space, external reinforced aluminum plating textured front and rear side of tool box which adds stability and longevity of product in extreme temperatures or environments, two outwards facing T-shaped locks which work independently from each other for ease of use and added security.

It is another key object of the invention that the ice chest portion of said invention will have a rotomolded structure which will double as a purpose of insulation from outside elements, from the tool box side, and added security, constructed to allow maximum space availability.

It is another object that the ice chest section will have a slightly downward tilted orientation to allow draining of melted ice conveniently, accompanying this will be a drainage hole stationed on the front of the ice chest side, at the intersection of the side, bottom, and corner which will allow water to run freely when hole is unfastened.

These and other objects and advantages will be described in more detail in the following descriptions made in connection with accompanying diagrams and additional information supporting claims and modifications, wherein like reference characters refer to the same or similar parts throughout several orientations and in which:

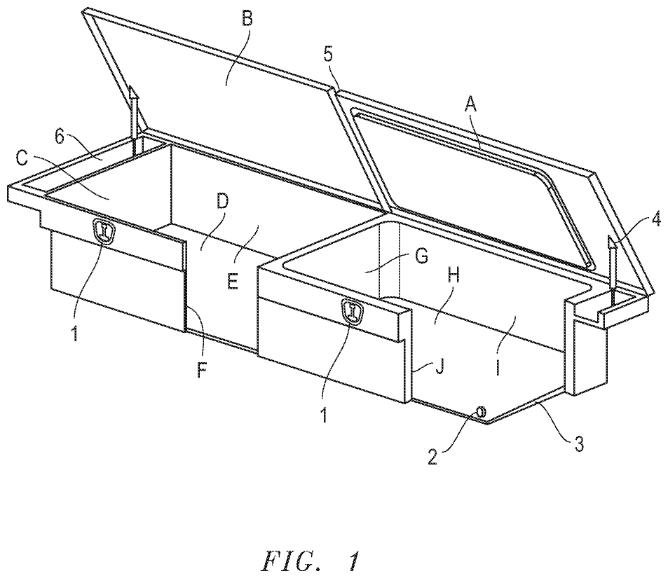

FIG. 1 is a perspective view of the ice chest/tool box combo (referred to as the “coolchest”) disclosed herein showing the hinging top cover in an open position and the inside components of both sides, including the self-draining angled bottom for the ice chest portion;

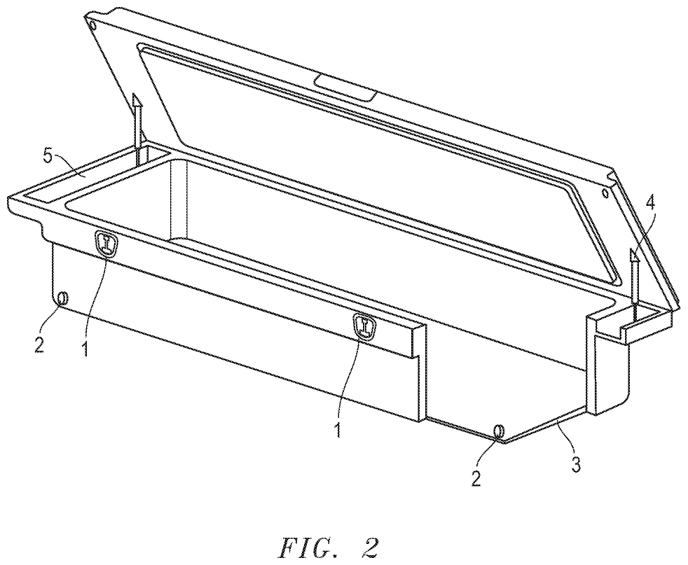

FIG. 2 is a the same perspective as FIG. 1, showing the full components of the full ice chest iteration disclosed herein, which will have a similar self-draining angled portion on the lower corner of the ice chest;

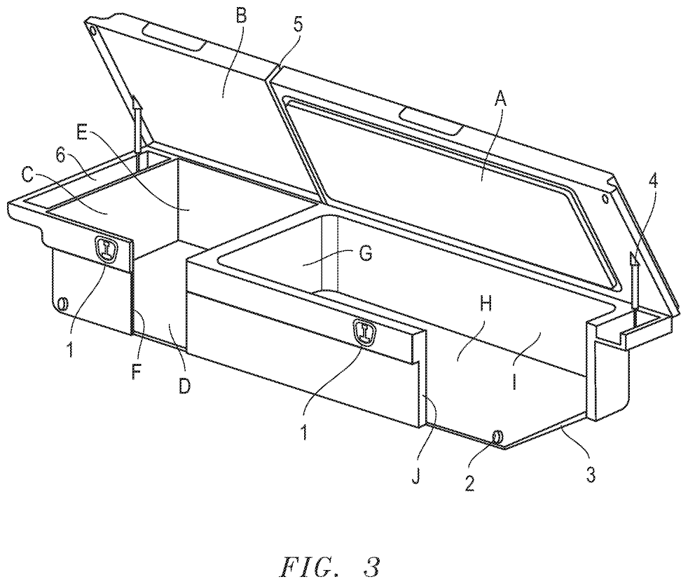

FIG. 3 is a the same perspective view as FIG. 1 and FIG. 2, detailing the components of the two-thirds ice chest, one-third tool box iteration, possessing the self-draining feature;

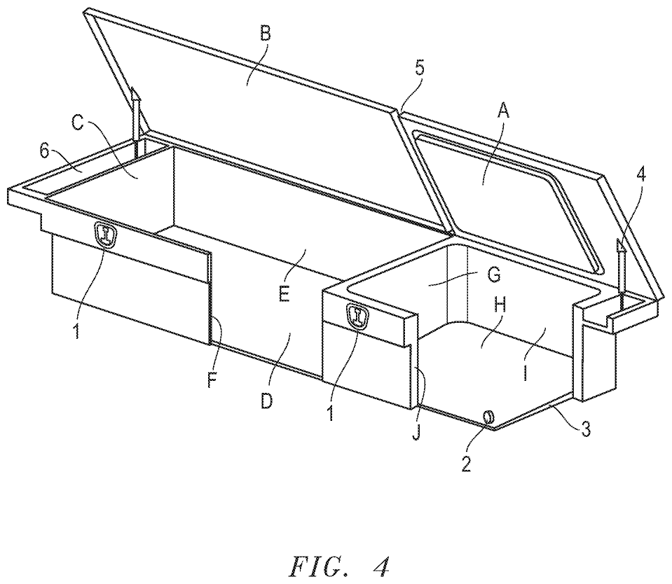

FIG. 4 is the same perspective as FIG. 1, FIG. 2, and FIG. 3, detailing the components of the one-third ice chest, two-thirds tool box iteration, possessing the self-draining feature;

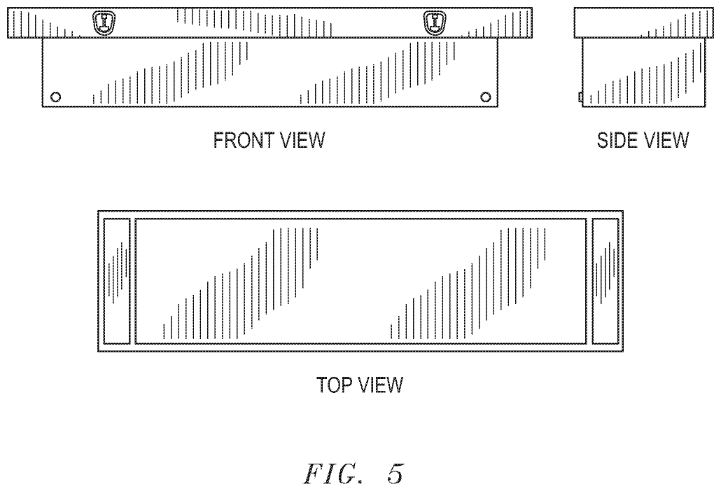

FIG. 5. Is a top down, profile view, and front view of the product detailing outside components, material, and texture for the product.

### DETAILED DESCRIPTION

As illustrated in the accompanying drawings, each diagram is an embodiment of the present invention which have a foundation of being “self-draining” by means of gravity. FIG. 1 is an embodiment of the invention, depicting the half ice chest, half tool box iteration of the invention used for storing tools, materials, keeping things secure on the tool box half side and for storing perishable items, beverages and things meant to be kept cool on the ice chest side. A rotomolded and polyurethane insulation on the ice chest end contoured to fitting the ice chest half provides insulation for the lid and attached to aluminum shell that will hold rotomold to the aluminum G, H, I a rotomolded interior (upright side walls, back and upright front of interior of ice chest) ensures durability and maximum insulation. The B aluminum lid on the tool box which hinges on has a foam seal around the lid to ensure maximum insulation for both ice chest and tool box sides 04 an all-weather stainless steel lever supports the aluminum lid which connects to an aluminum frame which permits a more lightweight design. The interior upright iteration of the tool box C, D, E, are textured along each face and treated so humidity and moisture is kept out of said tool box. The outside F is comprised of the similar aluminum material with a more rugged exterior, treated with the outside ledge 06 of ice chest (defined as an insulating device with a body and lid assembly which provides insulation when closed) and tool box (defined as a device with a body and lid assembly which provides storage space for tools, materials, and the like). The sides are reinforced for security for installation and subsequent product longevity. They are configured to be fastened to the vehicles exterior 03 securely. The rotomolded angled bottom provides an angled self-draining bottom that forces water out of the hole 02 when unplugged, fastened by a modified bailer plug. A hinged lever 04, perhaps comprised of all-weather stainless steel is connected in the form shown along each side of the diagram that has air-compression assistance for ease of use and safety when opening or closing each side. Two T-shaped stainless steel locks 01 work independently from one another to provide maximum insulation and safety for each side.

FIG. 2 is a different embodiment of an ice chest only variant. In this embodiment, a similar rotomolded ice chest design structure is illustrated as defined previously. This configuration may employ stainless steel T-shaped locks 01 and an angled, self-draining bottom rotomolded layer 03 which forces water out through both side holes 02 by means of gravity. A rotomolded exterior 05 is reinforced by metal brackets. Foam strips to protect the bedrails on the truck may be employed if no bedliner is already in place. Further, stainless steel hooks/bolts J may be utilized to attach the coolchest with the pre-drilled mounting slots to meet the specifications of each vehicle (e.g. approximately midway on each side of the coolchest on the sides), secured with a flat washer, and nut, and tightened down.

FIG. 3 is another embodiment of a one-third tool box, two-thirds ice chest configuration that possesses the same materials and features of FIG. 1 shifted to a smaller one-third tool box and two-thirds ice chest form. This may offer the same insulation, open/closing hinging mechanics and self-draining rotomolded bottom features.

FIG. 4 is yet another embodiment of a one-third ice chest, two-thirds ice chest configuration that possesses the same materials and features of FIG. 1 and FIG. 3 shifted to a smaller ice chest and two-thirds tool box. This may offer the same insulation, storage, open/closing hinging mechanics, and self-draining rotomolded bottom features.

FIG. 5 is a front, profile, and top down angle of all embodiments of the product, consisting of a textured surface and added measuring tape running along the lid closest towards the opening of the lid.

### CONCLUSION

Although this invention has been described in specific detail with reference to the disclosed embodiments, it will be understood that many variations and modifications or changes in material may potentially be effected within the scope of the invention as described in these appended claims.

1. A multi-purpose chest for secure integral incorporation into an open carriage location of a vehicle, the chest comprising:
an uninsulated compartment to accommodate non-temperature sensitive devices;
an insulated compartment to accommodate temperature sensitive items; and
a sloped surface below the insulated compartment to direct fluid drainage therefrom.

2. The chest of claim 1 wherein the non-temperature sensitive devices are manual tools and the temperature sensitive items are solid food or liquid consumables.
